(19) United States
(12) Patent Application Publication
(10) Pub. No.: US 2026/0136387 A1
(43) Pub. Date: May 14, 2026

(54) OPTIMIZING BATTERY EFFICIENCY THROUGH PREDICTIVE SATELLITE PASS SCHEDULING

(71) Applicant: T-Mobile USA, Inc., Bellevue, WA (US)

(72) Inventors: Roopesh Kumar Polaganga, Bothell, WA (US); Meenakshi Dhar, Bellevue, WA (US); Bharath Reddy Medarametla Lakshmi, Bellevue, WA (US)

(21) Appl. No.: 18/946,792

(22) Filed: Nov. 13, 2024

(51) Int. Cl. H04W 74/04; H04W 84/06

(52) U.S. Cl. CPC H04W 74/04; H04W 84/06

(57) ABSTRACT

Methods, systems, and apparatuses for optimizing battery efficiency of endpoint devices through predictive satellite pass scheduling are disclosed. A location of an endpoint device is determined. Non-terrestrial communication information associated with the location can be retrieved from a database of a communication network. A model can be applied to the non-terrestrial communication information to predict a time window for establishing non-terrestrial communication between the endpoint device and a non-terrestrial network at the location. A satellite associated with the non-terrestrial network can be monitored to obtain an actual time window for establishing non-terrestrial communication. The actual time window obtained is stored in the database of the terrestrial network, and subsequent time windows for non-terrestrial communication can be updated based on the actual time window obtained by monitoring the satellite.

### BACKGROUND

Wireless communications systems utilize base stations to communicate with end nodes. A common type of base station is a fixed-location base station, also referred to as a terrestrial base station, which is stationed at the surface of the Earth and supports telecommunications coverage to end nodes in surrounding areas. Another type of base station is a non-terrestrial base station, which operates from a space-based or airborne platform rather than being ground-based. The platforms can include satellites, high-altitude platforms (HAPs), and unmanned aerial vehicles (UAVs). The primary function of non-terrestrial base stations is to provide telecommunications coverage to end nodes similar to terrestrial base stations but with the added advantage of extended coverage and flexibility. Accordingly, network providers are increasingly utilizing non-terrestrial base stations to provide greater coverage to end nodes and provide improved networks.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a drawing that illustrates a method for predicting a time window of a satellite to establish non-terrestrial communication between an endpoint device and a non-terrestrial network with aspects of the present technology.

FIG. 4 illustrates an example model implementation platform implementing the model applied by a terrestrial network in accordance with some implementations of the present technology.

FIG. 5 is a drawing that illustrates an example wireless communications system supporting a non-terrestrial network (sometimes referred to as a satellite network) in accordance with aspects of the present technology.

FIG. 6 is a flow diagram that illustrates an example process in accordance with aspects of the present technology.

FIG. 7 is a drawing that illustrates an example wireless communications system associated with user equipment having dual connectivity with a terrestrial network and a satellite network in accordance with aspects of the present technology.

FIG. 8 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

As non-terrestrial networks (NTNs) are experiencing rapid advancements backed by significant investments and technological progress driven by a need for global communication infrastructure, telecommunications service providers are increasingly adopting NTNs to provide greater coverage to wireless devices of the telecommunications network. NTNs play a vital role in extending connectivity to hard-to-reach locations where traditional terrestrial networks are unable to provide coverage to wireless devices.

While NTNs offer multiple advantages, such as extended connectivity, support for communication for mobile platforms, and facilitation of global communication services, NTNs also come with distinct challenges. For example, deployment of NTNs requires substantial initial investment due to launch of satellites, and maintenance of the satellites can be prohibitive. Additionally, integrating NTNs with existing terrestrial networks can be complex and requires significant coordination to ensure seamless handover and interoperability between terrestrial and non-terrestrial components.

From the perspective of wireless devices, NTNs present challenges that can impact user experience and device performance. For example, wireless devices communicating with NTNs may require more power to maintain a stable connection, especially when connecting to satellites or high-altitude platforms. This can lead to increased battery drain and reduced device battery life. Additionally, the signal strength and quality from NTNs can be inconsistent, especially in areas with obstructions such as buildings, trees, or mountainous terrain. The inconsistent signals can result in dropped connections, lower data rates, and degraded experience. Further, seamless handover between terrestrial and non-terrestrial networks can be complex, resulting in brief interruptions or connectivity issues for users of wireless devices when transitioning between different network types.

This document discloses methods, systems, and apparatuses for optimizing battery efficiency of endpoint devices through predictive satellite pass scheduling. In some implementations, a location of an endpoint device is determined. Based on the location of the endpoint device, non-terrestrial communication information associated with the location can be retrieved from a database of a network, such as a terrestrial network. The non-terrestrial communication information can include satellite information, start and end time, duration of a time window for establishing non-terrestrial communication, elevation angle, and/or rise and set directions of the satellite. A model, such as a rule-based model or a trained machine learning model, can be applied to the non-terrestrial communication information to predict a time window for establishing non-terrestrial communication between the endpoint device and an NTN. The satellite associated with the NTN can be monitored to obtain an actual time window for establishing non-terrestrial communication. The actual time window obtained can be stored in the database of the terrestrial network. Subsequent time windows for non-terrestrial communication can be updated based on the actual time window obtained by monitoring the satellite.

By updating subsequent time windows for non-terrestrial communication, endpoint devices can be configured to schedule high-bandwidth operations during the time windows for non-terrestrial communication for improved signal quality. In some implementations, the endpoint device can be configured to operate in a non-terrestrial communication mode only during the predicted time window, and the non-terrestrial communication mode for the endpoint device can be disabled outside of the predicted time window.

The benefits and advantages of the implementations described herein include the use of a model to predict a time window for establishing non-terrestrial communication. By predicting a time window for non-terrestrial communication, an endpoint device can be configured to operate in a non-terrestrial communication mode only during times of direct satellite coverage to optimize data transmission between the endpoint device and the NTN and manage battery resource of the endpoint device effectively.

The methods disclosed herein cause a reduction in greenhouse gas emissions compared to traditional methods for operating telecommunication networks. Every year, approximately 40 billion tons of CO² are emitted around the world. Power consumption by digital technologies including telecommunications networks account for approximately 4% of this figure. By configuring user devices to operate in non-terrestrial mode only during designated time windows and enabling user devices to charge less frequently, overall demand for electricity is reduced, which, depending on the energy mix, can lead to lower greenhouse gas emissions. User device and application settings can sometimes exacerbate the causes of climate change. For example, the average U.S. power plant expends approximately 600 grams of carbon dioxide for every kWh generated. The implementations disclosed herein for conserving network resources can mitigate climate change by reducing and/or preventing additional greenhouse gas emissions into the atmosphere.

Additionally, disabling non-terrestrial communication outside of designated time windows, communication as described herein reduces overall electrical power consumption by requiring less frequent charging and extends device lifespan by reducing wear and tear on batteries. Extended device lifespan can lead to fewer devices being discarded and a reduction in the production of new devices. Manufacturing electronic devices can be energy-intensive and involves the extraction and processing of raw materials, which contribute to greenhouse gas emissions. Extending device lifespan can mitigate the emissions resulting from manufacture of electronic devices. Further, lower battery consumption can also reduce the need for frequent transportation of replacement batteries and devices. Therefore, the disclosed implementations for predicting satellite pass scheduling in order to configure endpoint devices for non-terrestrial communication during predicted time windows mitigate climate change and the effects of climate change by reducing battery consumption in devices compared to conventional network technologies.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

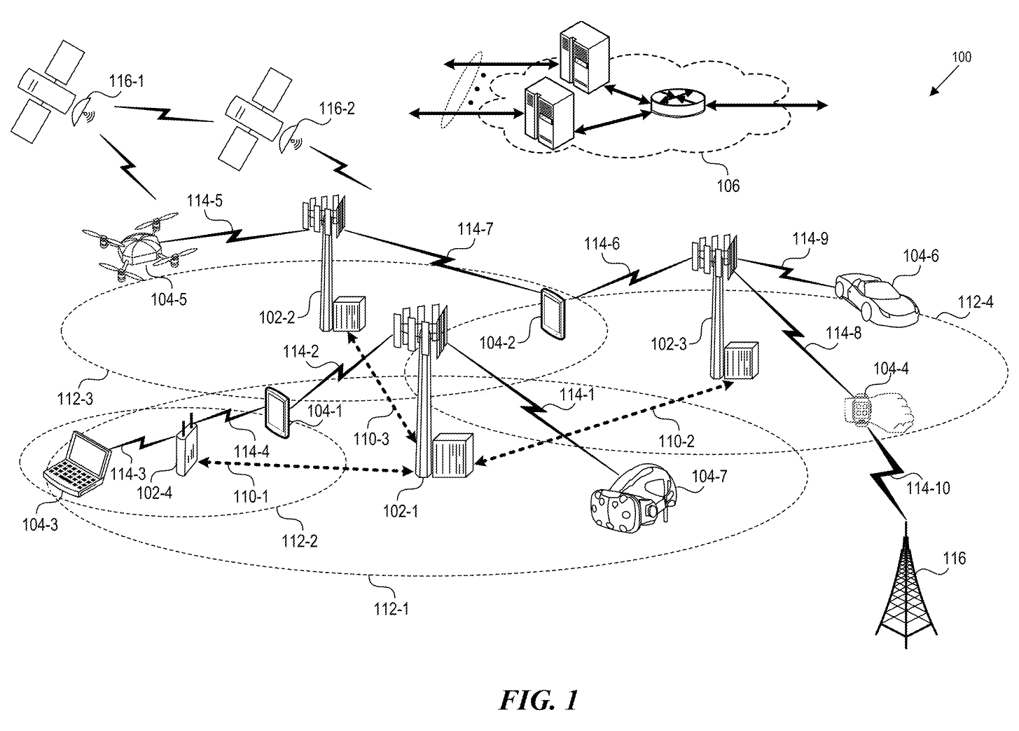

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term eNBs is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the 6G and beyond era, such as terabit-per-second backhaul systems, ultrahigh- definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

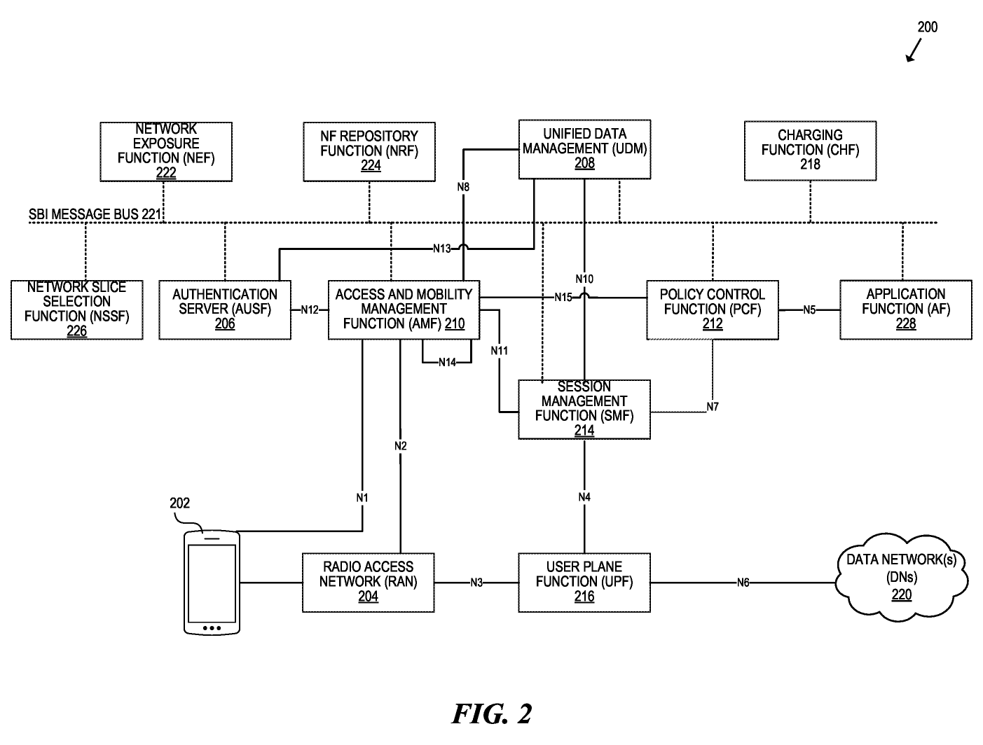

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control-plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control-plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

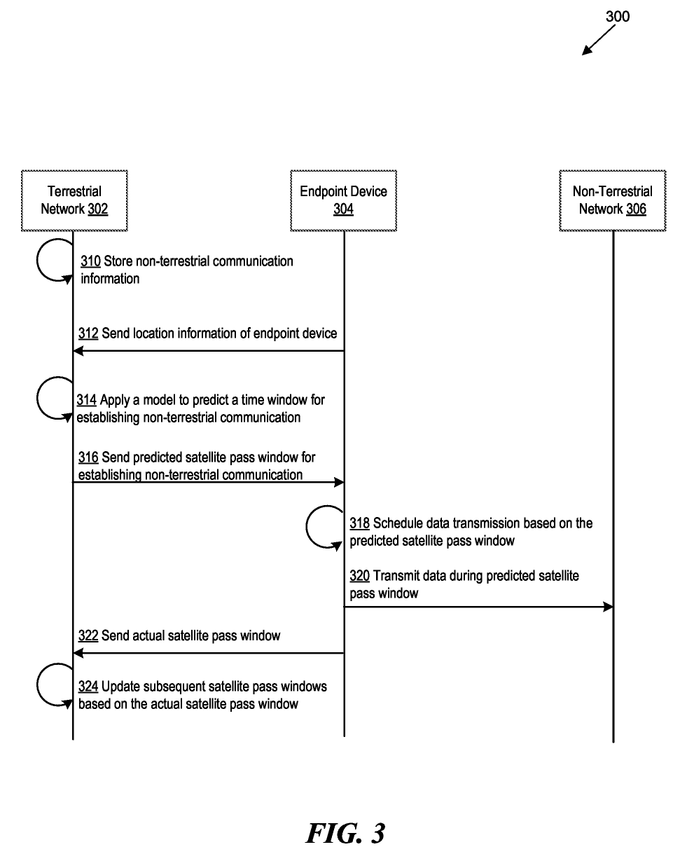

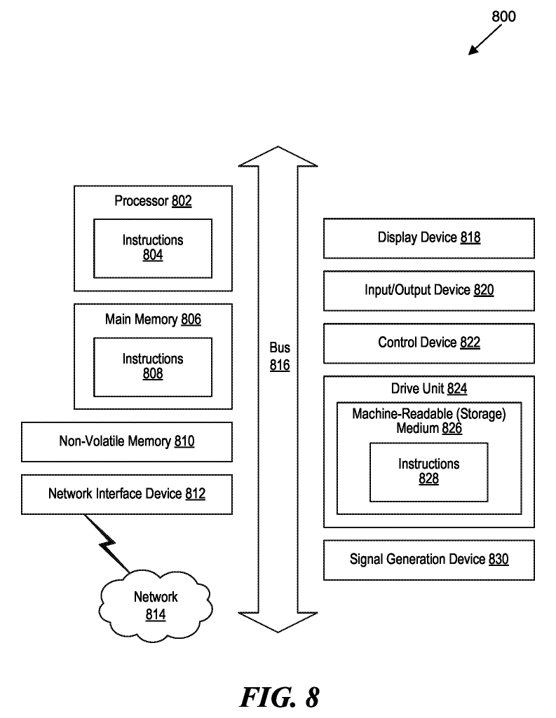

FIG. 3 is a drawing that illustrates a method 300 for predicting a time window of a satellite to establish non-terrestrial communication between an endpoint device 304 and a non-terrestrial network 306 with aspects of the present technology. A terrestrial network 302, the endpoint device 304, and the non-terrestrial network 306 can be implemented using processor 802 and instructions 808 programmed in the memory 806 illustrated and described in more detail with reference to FIG. 8. Although illustrated in a particular configuration, one or more operations of the method 300 may be omitted, repeated, or reorganized. Additionally, the method 300 may include other operations not illustrated in FIG. 3—for example, operations detailed in one or more other methods described herein.

As illustrated, the endpoint device 304 is capable of communicating with different network types. The endpoint device 304 can include a smartphone, a tablet, a laptop, a desktop, or an Internet of Things (IoT) device. The endpoint device 304 can be a mobile device, such as a smartphone or a tablet, or the endpoint device 304 can be a stationary device with low-to-no mobility, such as a smart thermostat, a set-top box, a modem, a router, etc.

The endpoint device 304 can be configured to communicate with terrestrial networks (e.g., a 3G, LTE, 4G, 5G, or other terrestrial network), such as a terrestrial network 302, or non-terrestrial networks. Terrestrial networks can be implemented through ground-based base stations locations on the surface of the Earth. Terrestrial networks can include a home terrestrial network, one or more partnered terrestrial networks, and one or more non-partnered terrestrial networks. The one or more partnered terrestrial networks can partner with the home network to provide communication services to devices of the home network in areas outside the coverage area of the home network.

In contrast, non-terrestrial networks, such as the non-terrestrial network 306, utilize space-based or airborne platforms, including satellites, high-altitude platforms (HAPs), and/or unmanned aerial vehicles (UAVs), to provide communication services to devices. The non-terrestrial networks can partner with the home network to provide communication services to devices of the home network in areas outside the coverage area of the home network.

At 310, the terrestrial network 302 stores non-terrestrial communication information in a database of the terrestrial network 302. The non-terrestrial communication information can include information related to the non-terrestrial network 306, such as information on satellites deployed by the non-terrestrial network 306 to provide communication services to devices. The satellite information can include information regarding satellite pass, which refers to a period of time during which a satellite is visible and can communicate with terrestrial networks and/or endpoint devices. Satellite pass information can include satellite identification information, start and end times of the satellite pass associated with a predetermined location, maximum elevation, azimuth and elevation angles, pass duration, ground track information, frequency information including frequencies to be used during the satellite pass, visibility information indicating the time of the day during which the satellite pass will occur as well as other conditions affecting visibility of the satellite, signal strength and quality information, etc. In some implementations, the database of the terrestrial network 302 is periodically updated to enable the terrestrial network 302 to work with up-to-date non-terrestrial communication information.

At 312, the endpoint device 304 can send location information of the endpoint device 304 to the terrestrial network 302. The location information of the endpoint device 304 can be obtained through various methods depending on the capability of the endpoint device 304. For example, the location information can be obtained using Global Positioning System (GPS), Wi-Fi positioning systems (WPS), IP address geolocation estimating the location based on the IP address associated with the endpoint device 304, or a combination of multiple positioning methods. The terrestrial network 302, upon receiving the location information from the endpoint device 304, can store the location information in the database of the terrestrial network 302. In some implementations, the endpoint device 304 is configured to periodically update location information of the endpoint device 304 such that the location information stored in the database of the terrestrial network 302 is real time or near real time.

At 314, based on the location information received from the endpoint device 304 and the non-terrestrial communication information stored in the database, the terrestrial network 302 can apply a model to predict a time window for establishing non-terrestrial communication between the endpoint device 304. The time window can be a satellite pass window during which devices located in a particular location are expected to receive direct satellite coverage. The model can be a rule-based model or a trainer machine learning (ML) model. For example, if the endpoint device 304 is a stationary or low-mobility device with minimal changes in location, a simple linear regression model can be applied to predict the time window for establishing non-terrestrial communication at a fixed location. If the endpoint device 304 is a mobility device such as a smartphone or a laptop, models such as a decision tree, random forest, and/or Light Gradient Boosting Machine (LightGBM) can be applied to predict the time window.

A “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

One or more of the machine learning models described herein can be trained with supervised learning, where the training data includes non-terrestrial communication information and location information as input and a desired output, such as a predicted satellite pass window associated with the endpoint device 304 at the identified location. Additionally, in some implementations, an actual satellite pass window, as identified by the endpoint device 304 or the terrestrial network 302, can be provided to the model to allow the model to calculate a deviation of the predicted satellite pass window with the actual satellite pass window. Based on the deviation, the model can be modified, such as by changing parameters of the functions used, to calculate subsequent satellite pass windows based on the actual satellite pass window.

At 316, the terrestrial network 302 can send the predicted satellite pass window for establishing non-terrestrial communication to the endpoint device 304. The predicted satellite pass window can indicate one or more satellite pass windows during which the endpoint device 304 is expected to receive direct satellite coverage, resulting in optimized non-terrestrial data transmission. In some embodiments, the terrestrial network 302 can periodically update the predicted satellite pass window based on updated location of the endpoint device 304. For example, if a user of the endpoint device 304 is traveling via a motor vehicle, the endpoint device 304 can periodically update the terrestrial network 302 with current location information of the endpoint device 304 such that the terrestrial network 302 can modify the predicted satellite pass window accordingly.

At 318, the endpoint device 304 can schedule non-terrestrial data transmission based on the predicted satellite pass window. At 320, the endpoint device 304 can transmit data to and from the non-terrestrial network 306 during the predicted satellite pass window. In some embodiments, to reduce battery consumption of the endpoint device 304, the endpoint device 304 can be configured to operate in a non-terrestrial communication mode only during the predicted satellite pass window. Outside of the predicted satellite pass window, the non-terrestrial communication mode for the endpoint device 304 can be disabled, resulting in reduced battery consumption of the endpoint device 304.

At 322, the endpoint device 304 can send the actual satellite pass window observed by the endpoint device 304 to the terrestrial network 302. The actual satellite pass window may or may not have overlaps with the predicted satellite pass window. The actual satellite pass window may be identical to the predicted satellite pass window. In some implementations, the terrestrial network 302 is configured to monitor one or more satellites associated with the non-terrestrial network 306 such that the terrestrial network 302 can observe the actual satellite pass window associated with the one or more satellites.

At 324, based on the actual satellite pass window observed by the endpoint device 304 or the terrestrial network 302, the terrestrial network 302 can update subsequent satellite pass windows. The update can include the terrestrial network 302 training the machine learning model with the actual satellite pass window as input and receiving the updated subsequent satellite pass windows as output.

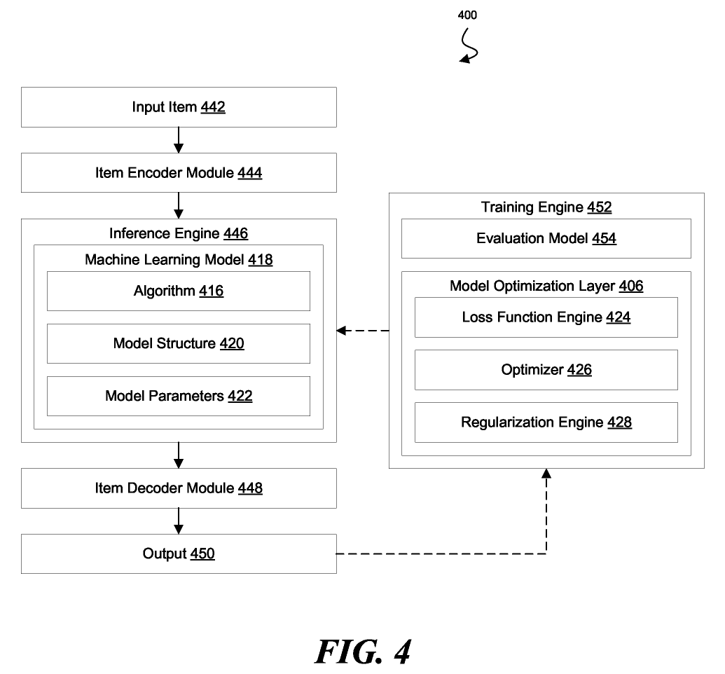

FIG. 4 illustrates an example model implementation platform 400 implementing the model applied by the terrestrial network 302 in accordance with some implementations of the present technology. According to various implementations, the model implementation platform 400 can include an inference engine 446 based on the machine learning model 418, algorithm 416, structure 420, and parameters 422. In additional or alternative implementations, the model implementation platform 400 can include a training engine 452 based on a separate evaluation model 454, the model optimization layer 406, loss function engine 424, optimizer 426, and regularization engine 428. In some embodiments, the model implementation platform 400 can include both the inference engine 446 and the training engine 452 in the workflow to train the model 418. In alternative or additional embodiments, the model implementation platform 400 can include the inference engine 446 without the training engine 452 in the workflow to make multiple model inferences without altering model parameters 422.

The algorithm 416 can be an organized set of computer-executable operations used to generate output data from a set of input data and can be described using pseudocode. The algorithm 416 can include program code that allows the computing resources to learn from new input data and create new/modified outputs based on what was learned. Once trained, the algorithm 416 can run at the computing resources to make predictions or decisions, improve computing resource performance, or perform tasks. The algorithm 416 can be trained using supervised learning, unsupervised learning, semi-supervised learning, self-supervised learning, reinforcement learning, and/or federated learning.

Using supervised learning, the algorithm 416 can be trained to learn patterns (e.g., match input data to output data) based on labeled training data. Supervised learning can involve classification and/or regression. Classification techniques involve teaching the algorithm 416 to identify a category of new observations based on training data and are used when the input data for the algorithm 416 is discrete. Said differently, when learning through classification techniques, the algorithm 416 receives training data labeled with categories and determines how features observed in the training data relate to the categories. Once trained, the algorithm 416 can categorize new data by analyzing the new data for features that map to the categories. Examples of classification techniques include boosting, decision tree learning, genetic programming, learning vector quantization, k-nearest neighbor (k-NN) algorithm, and statistical classification.

Federated learning (e.g., collaborative learning) can involve splitting the model training into one or more independent model training sessions, with each model training session assigned an independent subset training dataset of the training dataset. The one or more independent model training sessions can each be configured to train a previous instance of the model 418 using the assigned independent subset training dataset for that model training session. After each model training session completes training the model 418, the algorithm 416 can consolidate the output model, or trained model, of each individual training session into a single output model that updates model 418. In some implementations, federated learning enables individual model training sessions to operate in individual local environments without requiring exchange of data to other model training sessions or external entities. Accordingly, data visible within a first model training session is not inherently visible to other model training sessions.

Regression techniques involve estimating relationships between independent and dependent variables and are used when input data to the algorithm 416 is continuous. Regression techniques can be used to train the algorithm 416 to predict or forecast relationships between variables. To train the algorithm 416 using regression techniques, a user can select a regression method for estimating the parameters of the model. The user collects and labels training data that is input to the algorithm 416 such that the algorithm 416 is trained to understand the relationship between data features and the dependent variable(s). Once trained, the algorithm 416 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill in missing data for machine learning-based pre-processing operations.

Under unsupervised learning, the algorithm 416 learns patterns from unlabeled training data. In particular, the algorithm 416 is trained to learn hidden patterns and insights of input data, which can be used for data exploration or for generating new data. Here, the algorithm 416 does not have a predefined output, unlike the labels output when the algorithm 416 is trained using supervised learning. Said another way, unsupervised learning is used to train the algorithm 416 to find an underlying structure of a set of data, group the data according to similarities, and represent that set of data in a compressed format. The platform can use unsupervised learning to identify patterns in input data.

The model implementation platform 400 can be configured to perform model inference on an input item 442 using the inference engine 446. For example, the model implementation platform 400 can supply the inference engine 446 with the input item 442 and generate an inference output item 450. In some embodiments, the model implementation platform 400 can supply the input item 442 to an item encoder module 444 to generate an encoded input item that is supplied to the inference engine 446 in lieu of the raw input item 442. In additional or alternative embodiments, the model implementation platform 400 can supply an immediate output item of the inference engine 446 to an item decoder module 448 to generate the output item 450. To clarify, in lieu of the immediate output item of the inference engine 446, the output item 450 can be generated as the decoded output of the item decoder module 448. In some embodiments, the model implementation platform 400 can include the item encoder module 444, item decoder module 448, and/or any combination thereof.

In some embodiments, the input item 442 provided to the model implementation platform 400 can include a character sequence (e.g., a text string of characters such as data of satellite information), an image, an audio signal, a set of vectors, general data objects (e.g., a class instance comprising internal attributes and/or properties), and/or any combination thereof. In other embodiments, the output item 450 generated from the model implementation platform 400 can include an image and/or a set of images. In additional or alternative embodiments, the output item 450 can include a character sequence such as information related to a predicted satellite pass window, an audio signal, a set of vectors, general data objects, and/or any combination thereof.

In some embodiments, the item encoder module 444 and item decoder module 448 of the model implementation platform 400 can be a discrete set of algorithmic instructions to convert a source data item to a converted data item. For example, if the input item 442 was a multi-dimensional array of size m by n, the item encoder module 444 can be configured with a discrete set of algorithmic instructions to flatten the shape of the input item 442 array into a 1 by m x n shape array. In additional or alternative embodiments, the item encoder module 444 and item decoder module 448 can be individual neural network model layers separate from the model 418. In other embodiments, the item encoder module 444 and item decoder module 448 can be configured to ensure that the properties (e.g., array shape) of the converted data item adhere to a specified set of properties. For example, the item encoder module 444 can be configured to ensure that the input item 442 is converted into an acceptable input pattern for the model 418.

The model implementation platform 400 can be configured to perform model training on the output item 450 using the training engine 452. For example, the model implementation platform 400 can supply the training engine 452 with the output item 450 and generate a loss value using the loss function engine 424. The model implementation platform 400 can use the loss value generated from the loss function engine 424 to change and/or modify the model parameters 422 of the model used by the inference engine 446. In additional or alternative embodiments, the training engine 452 can include an evaluation model 454 that is separate from the model 318. In some embodiments, the evaluation model 454 can generate a loss-compatible output item from the output item 450 that can be used to calculate the loss value using the loss function engine 424.

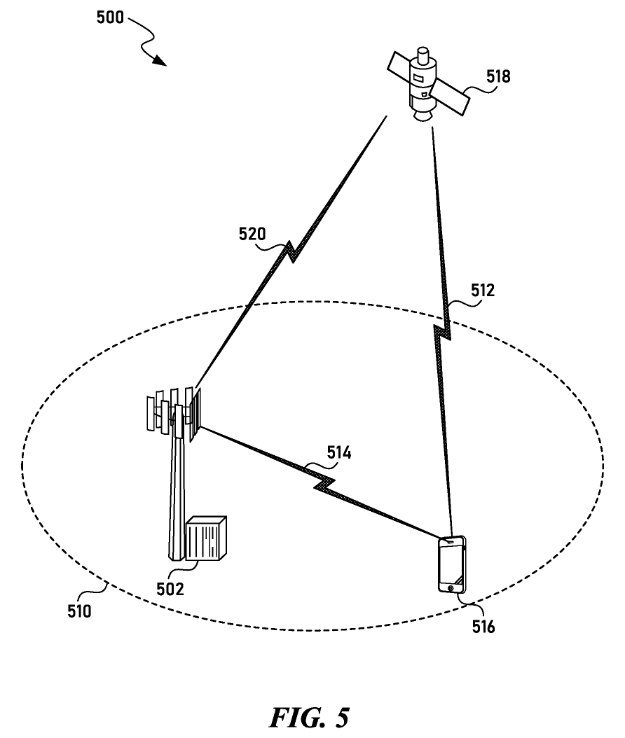

FIG. 5 is a drawing that illustrates an example wireless communications system 500 supporting a non-terrestrial network (sometimes referred to as a satellite network) in accordance with aspects of the present technology. A non-terrestrial network can, as an alternative to satellite 518, include high-altitude platforms (HAPs), such as stratospheric balloons, blimps, or the like. The wireless communications system 500 is implemented using components of the example computer system 800 illustrated and described in more detail with reference to FIG. 8. For example, the wireless communications system 500 can be implemented using processor 802 and instructions 808 programmed in the memory 806 illustrated and described in more detail with reference to FIG. 8. Likewise, implementations of the wireless communications system 500 can include different and/or additional components or be connected in different ways.

In some examples, the wireless communications system 500 implements aspects of the wireless telecommunications network 100 illustrated and described in more detail with reference to FIG. 1. The wireless communications system 500 includes a base station 502, an endpoint device 516, and a satellite 518, which are examples of the corresponding devices illustrated and described in more detail with reference to FIG. 1. The satellite 518 relays communications between base stations (e.g., base station 502) and mobile terminals (e.g., endpoint device 516). The base station 502 is sometimes referred to as a gateway. The geographical area associated with a transmission beam of the satellite 518 is sometimes called a beam footprint 510, and endpoint device 516 can communicate with the satellite 518 while the endpoint device 516 is located within the beam footprint 510. In some cases, the base station 502 is located within the beam footprint 510, and in other cases, the base station 502 is outside the beam footprint 510. Even when the base station 502 is located within the beam footprint 510, the base station 502 may be down or otherwise unavailable to provide connectivity to the endpoint device 516.

The satellite 518 generates satellite information (e.g., ephemeris information or network information) associated with communications between the satellite 518, the endpoint device 516, and/or the base station 502. The satellite 518 transmits, via a wireless communication link 520, the satellite information to the base station 502. The satellite 518 transmits, via a wireless communication link 512, the satellite information to the endpoint device 516 located within the beam footprint 510. The wireless communication link 512 is part of a non-terrestrial network. In some implementations, the endpoint device 516 relays, via a wireless communication link 514, the satellite information received from the satellite 518 to the base station 502.

The endpoint device 516 can receive network information from a communication network including the satellite 518. In some implementations (e.g., while endpoint device 516 is located within the beam footprint 510), the network information indicates that the communication network (including connectivity provided by the satellite 518) is available for use by the endpoint device 516.

In response to determining that the communication network is available, the endpoint device 516 connects to the communication network (including wireless communication link 512). The endpoint device 516 determines, based on the network information, that the communication network is a non-terrestrial communication network, as described in more detail with reference to FIGS. 3-4. In response to determining that the communication network is a non-terrestrial communication network, at least one software application installed on the endpoint device 516 can be rendered inoperable while the endpoint device 516 is connected to the non-terrestrial communication network. In some implementations, a software application is rendered inoperable based on device configuration data of the endpoint device 516.

In some embodiments, a user of the endpoint device 516 can select which non-terrestrial communication network to connect to when multiple satellite networks are available. Such a situation can occur when a mobile network operator of the endpoint device 516 has relationships with different non-terrestrial communication network providers. Each non-terrestrial communication network can have different constraints on resources and can provide different services or types of services. In some examples, a user could simply put endpoint device 516 into a power-saving mode when connecting to a non-terrestrial communication network.

In some implementations, while connected to a resource-constrained non-terrestrial communication network, the endpoint device 516 enters a lower-power state, also referred to as “sleep mode,” so as to reduce power consumption and increase battery life for the endpoint device 516. The endpoint device 516 can wake up on a schedule to receive a downstream transmission from base station 502 and/or the satellite 518. The time periods allocated prior to and following the wakeup actions can benefit the satellite 518 by reducing or eliminating interferences between the endpoint device 516 transmission and a transmission from another neighboring UE.

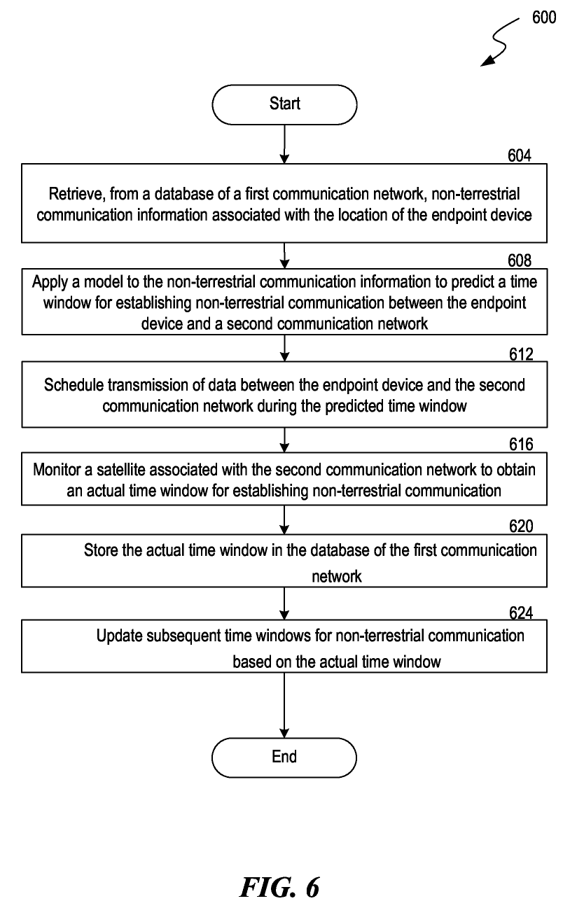

FIG. 6 is a flow diagram that illustrates an example process 600 in accordance with aspects of the present technology. In some implementations, the process 600 is performed by a communication network, such as the terrestrial network 302 as described in more detail with reference to FIG. 3. In some implementations, the process is performed by a computer system—e.g., example computer system 800 illustrated and described in more detail with reference to FIG. 8. Particular entities, such as endpoint device 304 or non-terrestrial network 306, perform some or all of the steps of the process 600 in other implementations. The endpoint device 304 and the non-terrestrial network 306 are illustrated and described in more detail with reference to FIG. 3. Likewise, implementations can include different and/or additional steps or can perform the steps in different orders.

At 604, a first communication network retrieves, from an internal database, non-terrestrial communication information associated with a location of an endpoint device. The first communication network can be a terrestrial network that provides communication services to the endpoint device. The non-terrestrial communication information can be information related to a non-terrestrial communication network and can include information of one or more satellites deployed and utilized by the non-terrestrial communication network to provide communication services. In some implementations, the endpoint device is a mobile device with changes in location over time. The endpoint device can be configured to periodically update the first communication network with real-time or near real-time location information of the endpoint device. Additional or other non-terrestrial communication information associated with the updated real-time or near real-time location information of the mobile device can be retrieved from the internal database.

At 608, the first communication network applies a model to the non-terrestrial communication information associated with the location of the endpoint device to predict a time window for establishing non-terrestrial communication between the endpoint device and a second communication network at the location of the endpoint device. The first communication network can feed non-terrestrial communication information associated with the location of the endpoint device, as well as historical data of previous satellite pass windows, as input to the model and receive as output a predicted time window for establishing non-terrestrial communication. The predicted time window for establishing non-terrestrial communication can indicate one or more satellite pass windows during which the endpoint device is expected to experience direct satellite coverage. For a mobile endpoint device with constantly changing location information, the first communication network can be configured to continuously monitor location information of the endpoint device and update the predicted time window accordingly.

At 612, based on the predicted time window, transmission of data between the endpoint device and the second communication network can be scheduled. To reduce power consumption, the endpoint device can be configured to enable non-terrestrial data transmission only during the predicted time window and enter “sleep” mode outside the predicted time window. By configuring the endpoint device to operate in non-terrestrial data transmission mode only during the predicted time window, the endpoint device can manage battery resources more effectively.

At 616, a satellite associated with the second communication network can be continuously monitored to obtain an actual time window for establishing non-terrestrial communication. The actual time window can be identical to the predicted time window, or the actual time window can have overlaps with the predicted time window. In some implementations, the actual time window and the predicted time window may have no overlap at all.

At 620, the actual time window of satellite pass is stored in the database of the first communication network. At 624, based on the actual time window, subsequent time windows for non-terrestrial communication can be updated. For example, the actual time window can be fed as input into the model employed by the first communication network. The model can output updated time windows for non-terrestrial communication, which the first communication network can transmit to the endpoint device to schedule subsequent non-terrestrial transmissions of data.

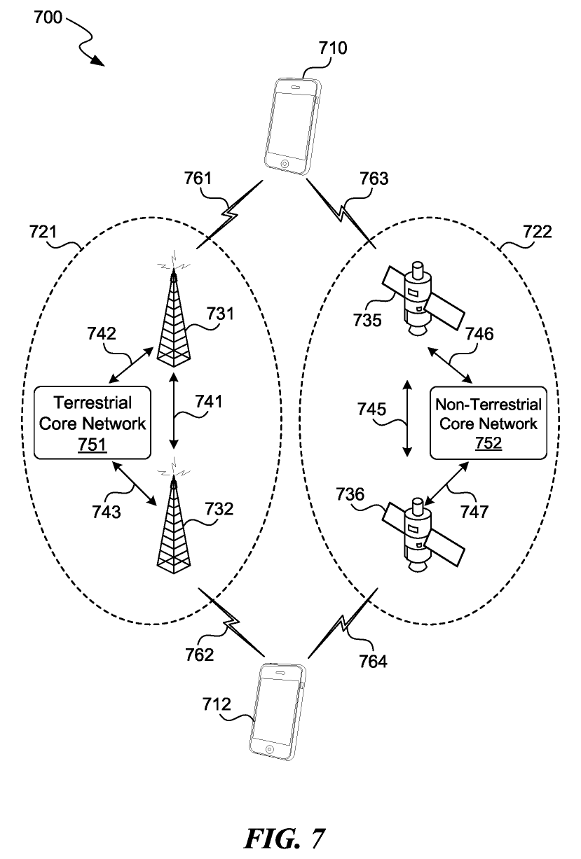

FIG. 7 is a drawing that illustrates an example wireless communications system 700 associated with user equipment having dual connectivity with a terrestrial network 721 and a satellite network 722 in accordance with aspects of the present technology. The wireless communications system 700 is implemented using components of the example computer system 800 illustrated and described in more detail with reference to FIG. 8. For example, the wireless communications system 700 can be implemented using processor 802 and instructions 808 programmed in the memory 806 illustrated and described in more detail with reference to FIG. 8. Likewise, implementations of the wireless communications system 700 can include different and/or additional components or be connected in different ways.

The wireless communications system 700 includes multiple endpoint devices 710 and 712 wirelessly communicating data using multiple wireless communication networks illustrated as wireless communication networks 721, 722. As shown in the example of FIG. 7, the endpoint device 710 is implemented as a smartphone. Although illustrated as a smartphone, the endpoint device 710 can be implemented as any suitable computing or electronic device, such as a mobile communication device, modem, cellular phone, gaming device, navigation device, media device, laptop computer, desktop computer, tablet computer, wearable computer, smart appliance, vehicle-based communication system, and the like. Also, in the example of FIG. 7, the endpoint device 712 is implemented as a smartphone (e.g., another user equipment). However, and in general, the endpoint device 712 can be any device that receives (or transmits) data via the wireless communication networks 721, 722. The endpoint device 712 can be, for example, a server or other hardware that is associated with a cloud storage service, a content provider (e.g., a video or music content provider), a ground-based destination network, or a general Internet access device.

The endpoint devices 710 and 712 engage with the first wireless communication network 721 using a first radio-access technology (RAT) that may operate in accordance with frequencies and protocols that may be associated with a Third-Generation partnership project long-term evolution (3GPP LTE) standard, a Fifth-Generation new radio (5G NR) standard, or any other suitable standard. The first wireless communication network 721 is configured to provide services to devices such as endpoint devices 710 and 712 when the devices are within a coverage area of the first wireless communication network 721.

The first wireless communication network 721 includes multiple wireless communication platforms illustrated as terrestrial base stations 731, 732 that are implemented in a macrocell, microcell, small cell, picocell, or the like. Furthermore, the terrestrial base stations 731, 732 can be an Evolved Universal Terrestrial Radio Access Network Node B, E-UTRAN Node B, evolved Node B, eNodeB, eNB, Next Generation Node B, gNode B, or a gNB terrestrial base station. The terrestrial base stations 731, 732 can communicate with elements of the wireless first wireless communication network 721 by way of one or more interfaces 741, 742, 743. Interface 741 may be, for example, an Xn interface, an X2 interface, or the like. Interfaces 742, 743 connect terrestrial base stations 731, 732 to terrestrial core network 751, which can include hardware of one or more servers, routers, switches, control elements, and the like that operate in accordance with frequencies and protocols that might be associated with a particular RAT standard. In embodiments where the terrestrial core network 751 is operating in accordance with protocols and frequencies that can be associated with the 5G NR standard, for example, interfaces 742, 743 can include a combination of an NG2 interface for control-plane signaling and an NG3 interface for user-plane data communications. In implementations where the terrestrial core network 751 operates in accordance with protocols and frequencies associated with the 3GPP LTE standard, interfaces 742, 743 include an S1 interface for control-plane signaling and user-plane data communications.

The endpoint devices 710 and 712 further engage with a second wireless communication network 722 using a second RAT that operates in accordance with frequencies and protocols associated with a Mobile Satellite Service (MSS). Furthermore, the second wireless communication network 722 includes one or more wireless communication platforms (satellites 735, 736), which are non-terrestrial and may be, for example, a low earth orbit (LEO) satellite, a medium earth orbit (MEO) satellite, or a geostationary earth orbit (GEO) satellite. The satellites 735, 736 communicate with elements of the second wireless communication network 722 by way of one or more interfaces 745, 746, 747. Interface 745 supports an inter-satellite link (ISL) connecting satellites 735, 736 and can be an optical interface, a laser interface, or a radio-frequency (RF) interface. Interfaces 746, 747 support gateway links (GWLs) connecting satellites 735, 736, respectively, to non-terrestrial core network 752 that can include hardware of one or more satellite ground stations, servers, routers, switches, control elements, and the like. Interfaces 746, 747 are, for example, Consultative Committee for Space Data Systems (CCSDS) interfaces.

As illustrated and as part of dual connectivity, the endpoint devices 710 and 712 are enabled to operate in a first engaged mode (terrestrial mode) with the terrestrial base station 731 of the first wireless communication network 721 by way of the wireless links 761 and 762, respectively, and in a second engaged mode (non-terrestrial mode) with the satellite 735 of the second wireless communication network 722 by way of the wireless links 763 or 764, respectively (the wireless links 763 and 764 to the satellite 735 may sometimes be referred to as mobile user link (MUL)). It is worth noting that such engagement modes (e.g., the first engaged mode and the second engaged mode) may correspond to engaged modes (or “connected” modes) as defined by respective RAT protocols and standards. In simple terms, an engaged mode may signify that an ongoing wireless connection has been established between the endpoint device and the terrestrial base station 731 and/or the satellite 735.

In an instance where the endpoint device 710 uses a same RAT to engage with the terrestrial base station 731 and the satellite 735, the endpoint device 710 may be in a single engaged mode. For example, if the endpoint device 710 is engaged with the base station 731 and the satellite 735 using a 5G NR RAT, the endpoint device 710 may be in an RRC_Connected mode as defined by 5G NR wireless protocols and standards. In such an instance, the separate wireless links 761, 763 may occur at physical (PHY), media access control (MAC), radio link control (RLC), or packet data convergent protocol (PDCP) layers that conform to 5G NR wireless protocols and standards.

The wireless communication platforms of the second wireless communication network may, as an alternative to satellites 735, 736, include high-altitude platforms (HAPs), such as stratospheric balloons, blimps, or the like (not illustrated in FIG. 7). In the instance of a second wireless communication network that includes HAPs, the QoS may not necessarily be the same as that in the instance of the second wireless communication network that includes satellites 735, 736.

In some implementations, a software application installed on the endpoint device 710 receives network information including a RAT type of the network 722 to which the endpoint device 710 is connected or about to connect. Different RAT types are described in more detail in the 3GPP Specification Release 17, which is incorporated by reference herein. The software application can be a streaming application and can stream at a first bit rate while the endpoint device 710 is connected to terrestrial communication network 721—e.g., a terrestrial network operated by a wireless service provider of the endpoint device 710. In accordance with the RAT type, the software application is configured to stream at a second bit rate lower than the first bit rate while the endpoint device 710 is connected to the non-terrestrial communication network 722. The endpoint device 710 and/or software application can also determine a type of wireless connection platform of a non-terrestrial network (e.g., HAP, GEO, LEO, or MEO). The endpoint device 710 and/or app can be configured to stream at different bit rates based on the type of wireless connection platform. Apps can also be enabled/disabled and/or grayed out based on the type of wireless connection platform that the endpoint device 710 is connected to.

### Computer System

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, a video display device 818, an input/output device 820, a control device 822 (e.g., keyboard and pointing device), a drive unit 824 that includes a machine-readable (storage) medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computing system 800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 800. In some implementations, the computer system 800 can be an embedded computer system, a system-on-chip (SOC), a single-board computer system (SBC) or a distributed system such as a mesh of computer systems, or it can include one or more cloud components in one or more networks. Where appropriate, one or more computer systems 800 can perform operations in real time, in near real time, or in batch mode.

The network interface device 812 enables the computing system 800 to mediate data in a network 814 with an entity that is external to the computing system 800 through any communication protocol supported by the computing system 800 and the external entity. Examples of the network interface device 812 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable (storage) medium 826 can include any medium that is capable of storing, encoding, or carrying a set of instructions for execution by the computing system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computing system 800 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variant thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A computer-implemented method for telecommunication, comprising:
determining a location of an endpoint device;
retrieving, from a database of a first communication network, non-terrestrial communication information associated with the location of the endpoint device,
wherein the first communication network is a terrestrial communication network;
applying a model to the non-terrestrial communication information to predict a time window for establishing non-terrestrial communication between the endpoint device and a second communication network,
wherein the second communication network is a non-terrestrial communication network; and
scheduling transmission of data between the endpoint device and the second communication network during the predicted time window;
monitoring a satellite associated with the second communication network to obtain an actual time window for establishing non-terrestrial communication;
storing the actual time window in the database of the first communication network; and
updating subsequent time windows for non-terrestrial communication based on the actual time window.

2. The method of claim 1, wherein the model is a rule-based model or a trained machine learning model.

3. The method of claim 1, wherein the location of a mobile device is a current location obtained using Global Positioning System (GPS) of the mobile device.

4. The method of claim 1, wherein the endpoint device is a mobile device, the method further comprising:
periodically updating the location of the mobile device; and
retrieving, from the database of the first communication network, other non-terrestrial communication information associated with the updated location of the mobile device.

5. The method of claim 1, further comprising:
configuring the endpoint device to operate in a non-terrestrial communication mode only during the predicted time window; and
disabling the non-terrestrial communication mode of the endpoint device outside of the predicted time window.

6. The method of claim 1, wherein the non-terrestrial communication information includes satellite information, start time, end time, duration of the time window for establishing non-terrestrial communication, elevation angle, and/or rise and set directions of the satellite.

7. A non-transitory, computer-readable storage medium comprising instructions recorded thereon, wherein the instructions, when executed by at least one data processor of a system, cause the system to:
determine a location of an endpoint device;
retrieve, from a database of a first communication network, non-terrestrial communication information associated with the location of the endpoint device;
apply a model to the non-terrestrial communication information to predict a time window for establishing non-terrestrial communication between the endpoint device and a second communication network; and
schedule transmission of data between the endpoint device and the second communication network during the predicted time window;
monitor a satellite associated with the second communication network to obtain an actual time window for establishing non-terrestrial communication;
store the actual time window in the database of the first communication network; and
update subsequent time windows for non-terrestrial communication based on the actual time window.

8. The non-transitory, computer-readable storage medium of claim 7, wherein the model is a rule-based model or a trained machine learning model.

9. The non-transitory, computer-readable storage medium of claim 7, wherein the location of a mobile device is a current location obtained using Global Positioning System (GPS) of the mobile device.

10. The non-transitory, computer-readable storage medium of claim 7, wherein the endpoint device is a mobile device, the instructions further cause the system to:
periodically update the location of the mobile device; and
retrieve, from the database of the first communication network, other non-terrestrial communication information associated with the updated location of the mobile device.

11. The non-transitory, computer-readable storage medium of claim 7, wherein the first communication network is a terrestrial communication network.

12. The non-transitory, computer-readable storage medium of claim 7, wherein the instructions further cause the system to:
configure the endpoint device to operate in a non-terrestrial communication mode only during the predicted time window; and
disable the non-terrestrial communication mode of the endpoint device outside of the predicted time window.

13. The non-transitory, computer-readable storage medium of claim 7, wherein the non-terrestrial communication information includes satellite information, start time, end time, duration of the time window for establishing non-terrestrial communication, elevation angle, and/or rise and set directions of the satellite.

14. A system comprising:
at least one hardware processor; and
at least one non-transitory memory storing instructions, which, when executed by the at least one hardware processor, cause the system to:
determine a location of an endpoint device;
retrieve, from a database of a first communication network, non-terrestrial communication information associated with the location of the endpoint device;
apply a model to the non-terrestrial communication information to predict a time window for establishing non-terrestrial communication between the endpoint device and a second communication network; and
schedule transmission of data between the endpoint device and the second communication network during the predicted time window;
monitor a satellite associated with the second communication network to obtain an actual time window for establishing non-terrestrial communication;
store the actual time window in the database of the first communication network; and
update subsequent time windows for non-terrestrial communication based on the actual time window.

15. The system of claim 14, wherein the model is a rule-based model or a trained machine learning model.

16. The system of claim 14, wherein the location of a mobile device is a current location obtained using Global Positioning System (GPS) of the mobile device.

17. The system of claim 14, wherein the endpoint device is a mobile device, the instructions further cause the system to:
periodically update the location of the mobile device; and
retrieve, from the database of the first communication network, other non-terrestrial communication information associated with the updated location of the mobile device.

18. The system of claim 14, wherein the first communication network is a terrestrial communication network.

19. The system of claim 14, wherein the instructions further cause the system to:
configure the endpoint device to operate in a non-terrestrial communication mode only during the predicted time window; and
disable the non-terrestrial communication mode of the endpoint device outside of the predicted time window.

20. The system of claim 14, wherein the non-terrestrial communication information includes satellite information, start time, end time, duration of the time window for establishing non-terrestrial communication, elevation angle, and/or rise and set directions of the satellite.
